(19) United States
(12) Patent Application Publication
(10) Pub. No.: US 2010/0023912 A1
(43) Pub. Date: Jan. 28, 2010

(54) LEAD FRAME DESIGN SUPPORT APPARATUS AND LEAD FRAME DESIGN SUPPORT METHOD

(75) Inventor: Keisuke SUZUKI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, KAWASAKI (JP)

(21) Appl. No.: 12/480,167

(22) Filed: Jun. 8, 2009

(30) Foreign Application Priority Data
Jul. 22, 2008 (JP) 2008-189140

(51) Int. Cl. G06F 17/50

(52) U.S. Cl. 716/12

(57) ABSTRACT

A lead frame design support apparatus and method include measuring a signal waveform transition time, calculating a distributed parameter unit length based on the transition time measured, calculating a division number for a lead frame by dividing the lead frame by the distributed parameter unit length calculated, and determining a respective line width for each lead frame divided by the division number calculated, based on a signal waveform quality.

### CROSS-REFERENCE TO RELATED APPLICATIONS

This application claims the benefit of Japanese Patent Application No. 2008-189140, filed on Jul. 22, 2008, the disclosure of which is incorporated herein by reference.

### FIELD

Embodiments of the invention relate to lead frame design support apparatus, lead frame design support methods, and lead frame design support programs, which support designing of, for example, a lead frame of a lead frame structure package.

### BACKGROUND

In recent years, there has been a situation where even a QFP (Quad Flat Package) that is severe in electrical characteristics needs to have a high-speed interface as demand for cost reduction escalate. In addition, as the technology of ASIC (Application Specific Integrated Circuit) advances, the die size of LSI (Large Scale Integration) has become smaller, but the package size remains unchanged under the present circumstances. As a consequence, the lead frame of the package has become longer than before, and accordingly, the electrical characteristics of the QFP have become more severe.

There is a technique for reducing the noise in a QFP package. In this technique, as illustrated in FIG. 11, noise reduction is achieved by adding a component for reducing noise to a PCB board on which the package is mounted, or by changing the material of the package.

The above-described technique has problems including the problem of an increase in the parts count because the component for reducing noise is added onto the PCB board. In addition, since the material for the lead frame structure package is changed, there is another problem that the cost increases because of the use of the material that is not existing materials.

### SUMMARY

According to an aspect of the invention, a lead frame design support apparatus and method. The apparatus, for example, includes a signal waveform measuring unit that measures a signal waveform transition time, a distributed parameter calculating unit that calculates a distributed parameter unit length based on the transition time measured by the signal waveform measuring unit, a division calculating unit that calculates a division number for a lead frame by dividing the lead frame by the distributed parameter unit length calculated by the distributed parameter calculating unit, and a line width determining unit that determines a respective line width for each lead frame divided by the division number calculated by the division calculating unit, based on a signal waveform quality.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a configuration of a lead frame design support apparatus according to an embodiment of the invention.

FIG. 2 illustrates an example of a line width aimed at improving a waveform quality.

FIG. 3 illustrates another example of a line width aimed at improving a waveform quality.

FIG. 4 illustrates another example of a line width aimed at improving a waveform quality.

FIG. 5A illustrates a process for determining a line width aimed at improving a waveform quality.

FIG. 5B illustrates another process for determining a line width aimed at improving a waveform quality.

FIG. 6 illustrates a package board in which a shape of a lead frame is controlled per unit length.

FIG. 7 is a flowchart illustrating a procedure for a lead frame design support apparatus according to an embodiment.

FIG. 8 illustrates an operation of a lead frame design support apparatus according to an embodiment.

FIG. 9 illustrates another operation of a lead frame design support apparatus according to an embodiment.

FIG. 10 illustrates a computer that executes a lead frame design support program.

FIG. 11 illustrates an example of a technique for reducing a noise in a QFP package.

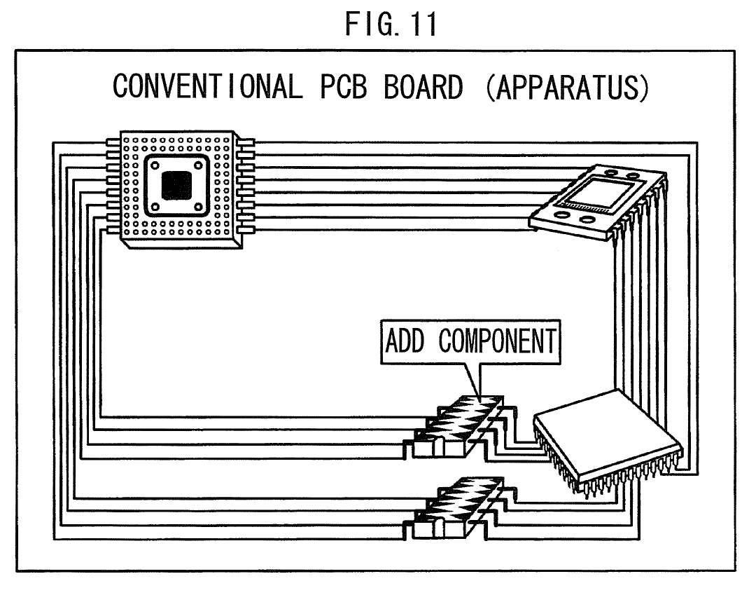

### DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Hereinbelow, with reference to the attached drawings, embodiments of the lead frame design support apparatus, the lead frame design support method, and the lead frame design support program according to the invention will be described in detail.

The configuration and the process flow of a lead frame design support apparatus according to an embodiment will be described, and subsequently, effects of this embodiment will be explained. The following describes an example in which an embodiment of the invention is applied to an apparatus for supporting design of a QFP package with a lead frame structure used on a PCB board.

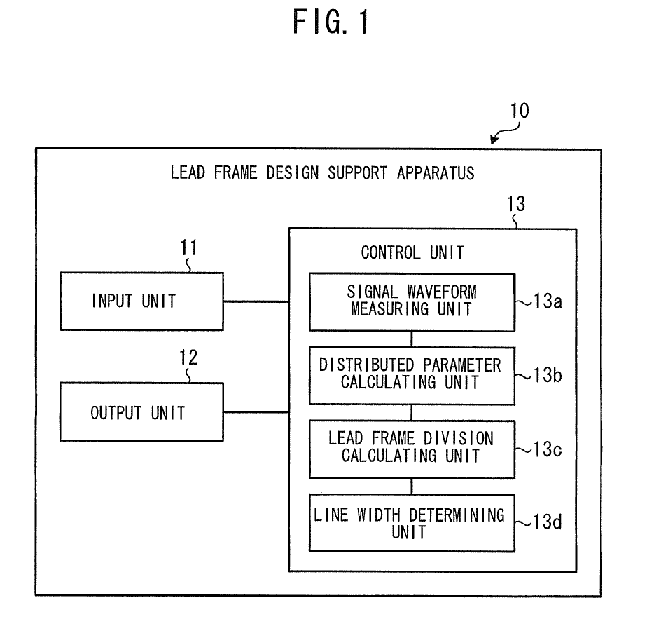

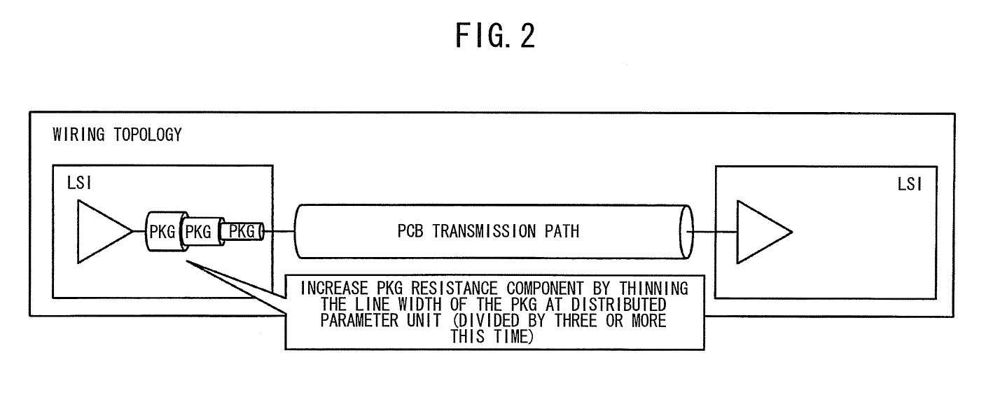

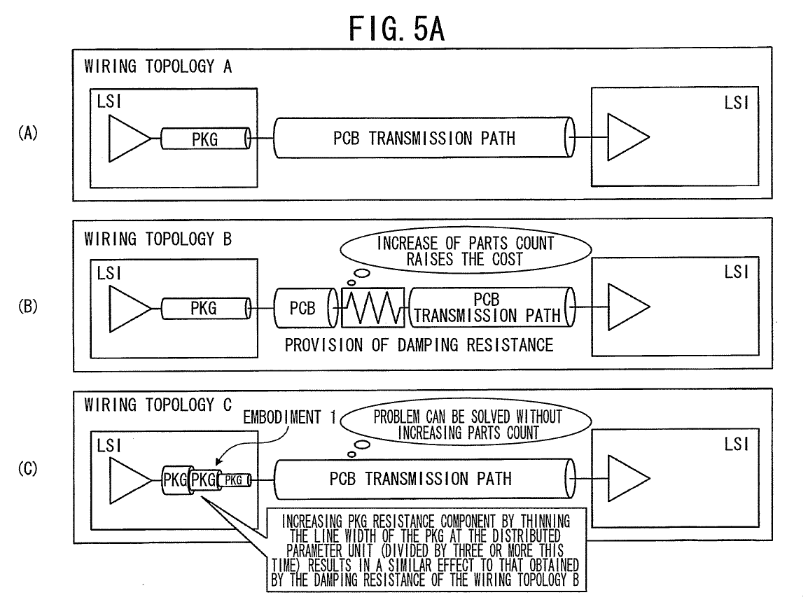

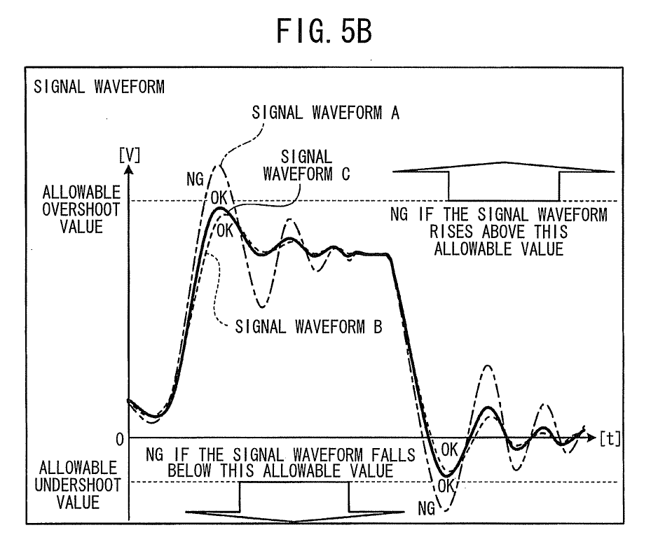

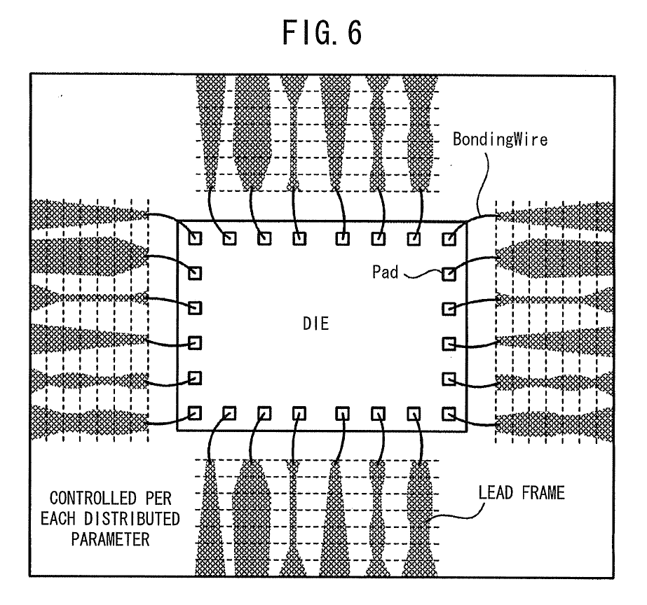

The configuration and operation(s) of a lead frame design support apparatus 10 according to an embodiment will be described with reference to FIGS. 1 through 6. FIG. 1 illustrates the configuration of the lead frame design support apparatus 10 according to an embodiment. FIGS. 2 through 4 illustrate examples of the package wiring in which a line width has been changed to improve a waveform quality. FIGS. 5A and 5B illustrate a process for determining a line width to improve a waveform quality. FIG. 6 illustrates a package board in which a shape of the lead frame is controlled per unit length.

As illustrated in FIG. 1, the lead frame design support apparatus 10 according to an embodiment has an input unit 11, an output unit 12, and a control unit 13. Hereinbelow, the processes in these components will be described.

The input unit 11 enables input of various information such as a length of a lead frame of a package. The input unit 11 includes a keyboard, a mouse, etc. The output unit 12 provides information including by displaying, for example, a line width of a lead frame determined by a line width determining operation according to an embodiment. The output unit 12 may be a monitor or a display, a touch panel, a speaker, and the like.

The control unit 13 has an internal memory (not shown) for storing necessary data and program(s) that specify various process procedure(s) such as a lead frame design support program. The control unit executes various processes by these programs and data. The control unit 13 has the function(s) corresponding to a signal waveform measuring unit 13a, a distributed parameter calculating unit 13b, a lead frame division calculating unit 13c, and a line width determining unit 13d.

The signal waveform measuring unit 13a measures signal waveform transition time. As a technique of measuring a signal waveform transition time, the signal waveform measuring unit 13a actually measures the transition time of the signal waveform that propagates on the line with an oscilloscope, or measures the transition time of the signal waveform that is output with a circuit simulation model. The signal waveform measuring unit 13a notifies the measured transition time to the distributed parameter calculating unit 13b, which is described in detail below. Here, the rise time or the fall time of the signal waveform is measured as the signal waveform transition time.

The distributed parameter calculating unit 13b calculates a distributed parameter unit length based on the signal waveform transition time measured by the signal waveform measuring unit 13a. The distributed parameter calculating unit 13b determines an appropriate distributed parameter unit length for the signal line based on the signal line length through which the signal propagates within the signal waveform transition time, and notifies that to the later-described lead frame division calculating unit 13c. The distributed parameter unit length for a signal line can be calculated according to the following equation.

Distributed parameter unit length=Transition time/Propagation delay of the line

For example, when the rise time or fall time of a signal waveform is 50 ps and the propagation delay of the package line is 6.5 ns/m, the distributed parameter calculating unit 13b determines the distributed parameter unit length to be 50 [ps]/6.5 [ns/m]=7.69 mm.

The calculated value of 7.69 mm is the signal line length by which the signal propagates during the signal waveform transition time, that is, the distributed parameter unit length. In other words, when the rise time or fall time of the signal is 50 ps, it is necessary to control the line length and width by a unit of 7.69 mm or less. If the line length and width is controlled with the distributed parameter unit length or greater, there is a possibility that the signal waveform may not be controlled appropriately and the signal waveform may not be controlled so as to be, for example, an allowable overshoot value and an allowable undershoot value. In contrast, the lead frame design support apparatus 10 according to an embodiment can control the signal waveform more finely because the lead frame design support apparatus 10 divides the lead frame using the distributed parameter unit length as a unit.

The lead frame division calculating unit 13c calculates a division number for a lead frame by dividing the lead frame of a package by the distributed parameter unit length. In the following explanation, the above-described example is taken as an example. When a lead frame length of the package is 21 mm, the lead frame division calculating unit 13c divides the lead frame length 21 mm by the distributed parameter unit length 7.69 mm to yield “21 mm/7.69 mm=3”. Thereby, an effective division number for the lead frame is equal to or greater than 3.

The line width determining unit 13d calculates and determines a respective line width to improve the waveform quality for each section of the division unit of the lead frame that is divided by the division number calculated by the lead frame division calculating unit 13c, based on the signal waveform quality. The line width determining unit 13d outputs an image of the determined line width from the output unit 12.

FIGS. 2 through 4 illustrate wiring topologies as examples of a line width adjustment to improve the waveform quality. FIGS. 2 through 4 illustrate packages of opposing LSIs that are connected to each other by a PCB transmission path. It should be noted that in the above described embodiment, the line width of the package line (denoted as “PKG” in the figures), in other words, the lead frame, that is on the left of each of FIGS. 2 through 4 is controlled. Here, as illustrated in FIG. 2, the line width determining unit 13d increases the package resistance component by gradually thinning the line width of the lead frame at every division unit toward the PCB transmission path.

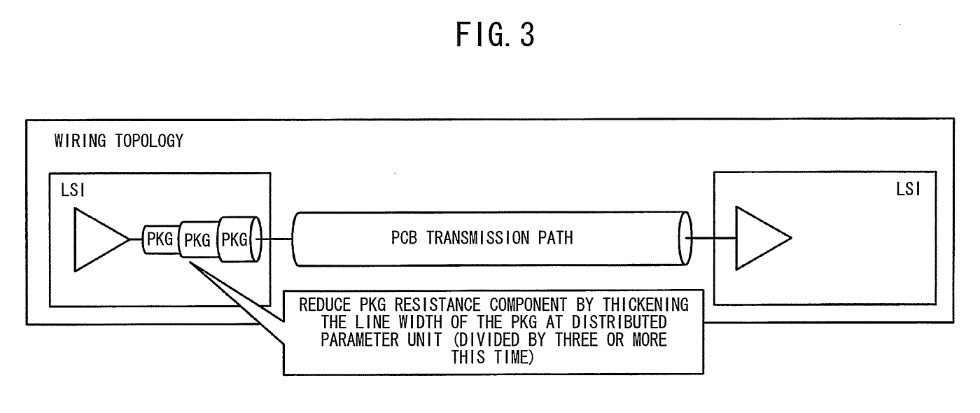

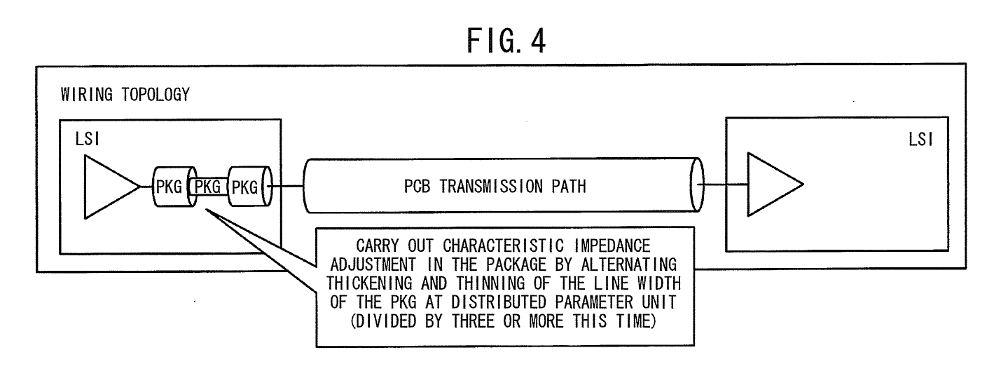

Alternatively, as illustrated in FIG. 3, the line width determining unit 13d decreases the package resistance component by gradually thickening the line width of the lead frame at every division unit toward the PCB transmission path, as an example of the line width adjustment. Alternatively, as illustrated in FIG. 4, the line width determining unit 13d may carry out characteristic impedance adjustment in the package by alternating a portion with a thick line width of the lead frame and a portion with a thin line width of the lead frame at every division unit.

With reference to FIGS. 5A and 5B, a process for determining the line width to improve the waveform quality is described in detail. FIG. 5A illustrates three types of wiring topologies. (A) illustrates a wiring topology in the case that the package line width is not changed. (B) illustrates a wiring topology in the case that a damping resistor is disposed in a portion of the wiring line, in a PCB transmission path in the example of FIG. 5A. (C) illustrates a wiring topology in the case that the line width of the package line is changed partially, in particular, an example in which the package resistance component is increased by gradually thinning the line width at every division unit.

FIG. 5B illustrates respective signal waveforms in the wiring topologies illustrated in FIG. 5A. It should be noted that the signal waveform A illustrated in FIG. 5B corresponds to the wiring topology A illustrated in FIG. 5A. Likewise, the signal waveform B corresponds to the wiring topology B and the signal waveform C corresponds to the wiring topology C, respectively. Also, FIG. 5B illustrates two allowable values, an allowable overshoot value and an allowable undershoot value, which are compared to the signal waveforms. It is determined that there is a problem in the quality assurance of the signal waveform when the signal falls outside the allowable values.

As illustrated in FIG. 5B, the wiring topology A has a problem in the waveform quality assurance because the signal waveform A, represented by the dot-dashed line, falls outside the allowable overshoot value and the allowable undershoot value considerably.

With the wiring topology B, in which a damping resistor is provided, the signal waveform B indicated by dotted line the stays within a range of the allowable overshoot value and the allowable undershoot value, so the waveform quality improves; however, the parts count increases and the cost becomes high.

In contrast the wiring topology B, the package resistance component is increased in the wiring topology C determined according to the above described embodiment so that the line widths of the lead frame that is divided into three portions are adjusted to be thinner. As a result, the signal waveform C, which is indicated by the solid line, stays within the range of the allowable overshoot value and the allowable undershoot value, as with the signal waveform B. As a result, it is possible to improve the waveform quality, and also the wiring topology C can reduce the cost without increasing the parts count in comparison with the wiring topology B.

Thus, the lead frame design support apparatus 10 derives a lead frame line width that improves the waveform quality, and allows designing of a package board as illustrated in FIG. 6, in which the shape of the lead frame is controlled at every unit length. Specifically, in the package board of the example illustrated in FIG. 6, a plurality of pads provided on a die are connected to the lead frames via the bonding wires. Then, each of the lead frames has a shape and width calculated individually by the lead frame design support apparatus 10. It should be noted that the dotted lines in FIG. 6 denote division lines at distributed parameter units.

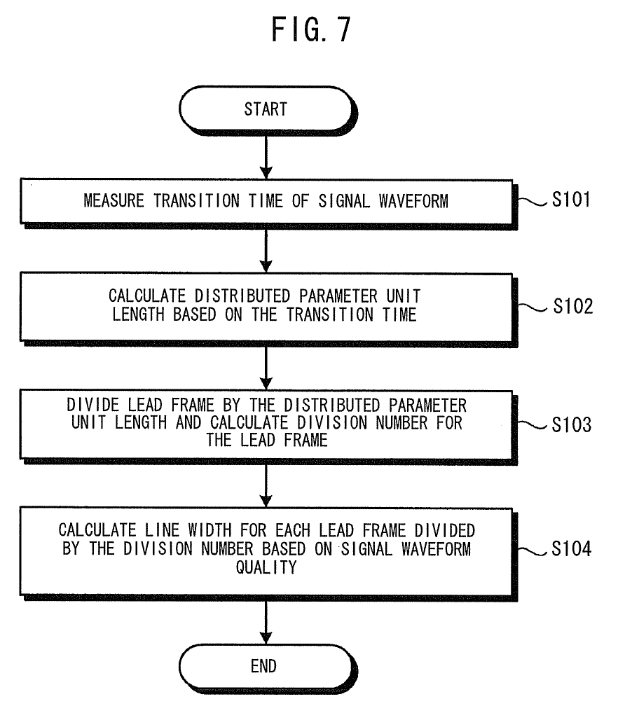

Next, the process executed by the lead frame design support apparatus 10 according to the above described embodiment will be described with reference to FIG. 7. FIG. 7 is a flowchart illustrating a procedure for the lead frame design support apparatus 10 according to an embodiment.

As illustrated in FIG. 7, the lead frame design support apparatus 10 measures a transition time of a signal waveform (S101). Then, the lead frame design support apparatus 10 calculates a distributed parameter unit length based on the measured transition time (S102). Subsequently, the lead frame design support apparatus 10 calculates a division number for the lead frame by dividing the lead frame by the distributed parameter unit length (S103).

Thereafter, the lead frame design support apparatus 10 determines a respective line width for every distributed unit length, for each lead frame divided by the calculated division number, based on the signal waveform quality (S104). Specifically, the lead frame design support apparatus 10 determines a respective line width aimed at improving the waveform quality, for each section of the lead frame that has been divided by the calculated division number. For example, the lead frame design support apparatus 10 increases the package resistance component by gradually thinning the line width of the lead frame at every division unit toward the PCB transmission path (see FIG. 2).

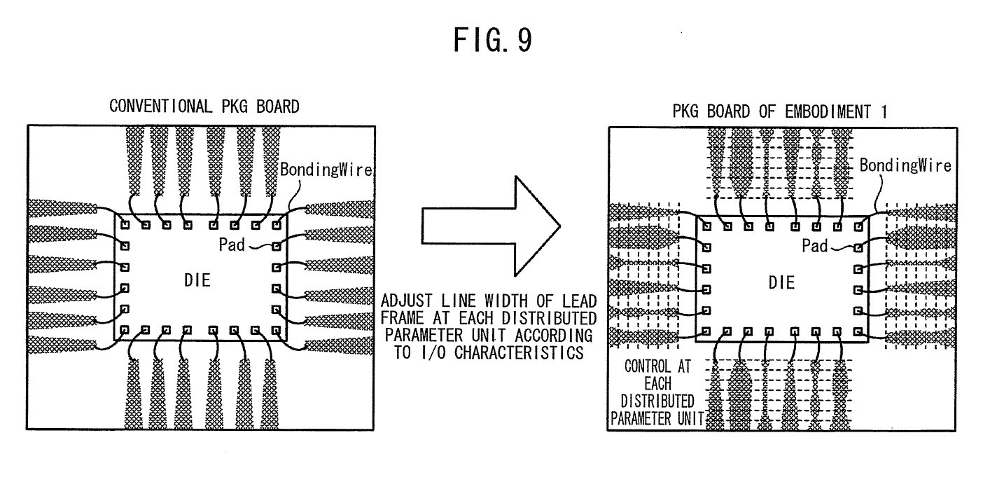

As has been described above, the lead frame design support apparatus 10 measures a transition time of a signal waveform, calculates a distributed parameter unit length based on the measured transition time, divides the lead frame by the calculated distributed parameter unit length to calculate a division number for the lead frame. Then, the lead frame design support apparatus 10 determines a respective line width for each lead frame divided by the calculated division number, based on a signal waveform quality. Accordingly, as illustrated in FIG. 9, the lead frame design support apparatus 10 of the above described embodiment can derive a lead frame line width that can achieve improvements in terms of the waveform quality, in contrast to the conventional package board in which the shape of the lead frame is invariable. Also, the lead frame design support apparatus 10 of the above described embodiment controls the shape of the lead frame by each unit length. As a result, it is possible to reduce noise and achieve improvements in the waveform quality.

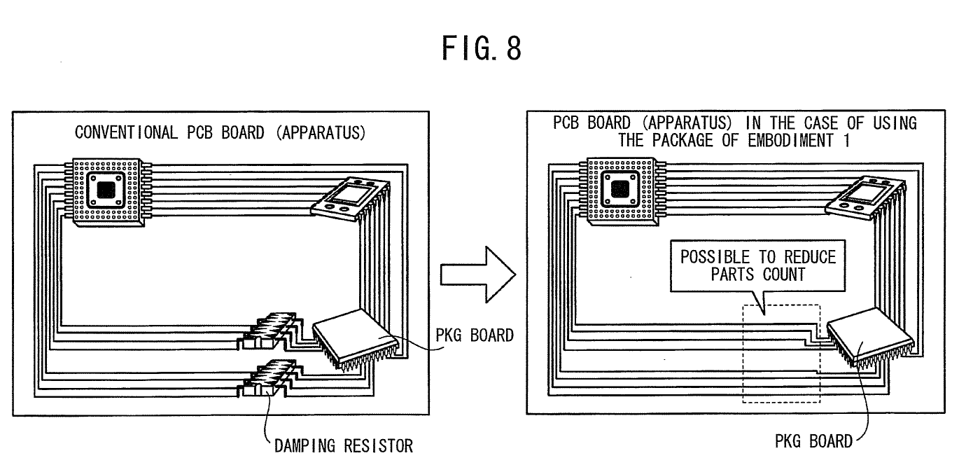

Furthermore, as illustrated in FIG. 8, the lead frame design support apparatus 10 eliminates the component(s) provided on the conventional PCB board, such as damping resistors. Therefore, it is possible to decrease the parts count and reduce the cost.

In addition, according to an embodiment, the lead frame design support apparatus 10 measures the rise time or the fall time of the signal waveform as the transition time of the signal waveform. Therefore, the lead frame design support apparatus 10 according to the above described embodiment can measure the transition time of the signal waveform from the rise time or the fall time of the signal waveform.

Moreover, according to an embodiment, the lead frame design support apparatus 10 determines the line width to be thinned when the resistance is to be increased. Therefore, in such a case that the waveform goes outside the allowable overshoot value and the allowable undershoot value considerably, an embodiment makes it possible to cause the waveform to be within the range of the allowable overshoot value and the allowable undershoot value by increasing the resistance to improve the waveform quality.

Furthermore, according to an embodiment, the lead frame design support apparatus 10 determines the line width to be thickened when the resistance is to be reduced, and therefore, it is possible to improve the waveform quality by increasing the resistance.

What is more, according to an embodiment, the lead frame design support apparatus 10 determines the line width so that a portion in which the line width is thick and a portion in which the line width is thin are alternated when the impedance is to be adjusted, and therefore, it is possible to improve the waveform quality by controlling the impedance.

An embodiment has been described thus far, but the invention may be embodied in various different embodiments, other than the above-described embodiment. For this reason, another embodiment of the invention will be described below.

The components of the apparatus that have been illustrated in the drawings thus far are functional and conceptual, and do not need be configured in the manners illustrated in the drawings physically. Specifically, the specific configuration of the distribution and integration of the devices are not limited to those illustrated in the drawings, but the whole or part thereof may be configured to be distributed and integrated functionally or physically in any units according to the various loads and use conditions. For example, the signal waveform measuring unit 13a and the distributed parameter calculating unit 13b may be integrated with each other. Moreover, the whole or part of the process functions executed in the respective devices may be implemented by a CPU or a program that is analyzed and executed by the CPU, or it may be realized by hardware using wired logic.

Furthermore, the whole or part of the processes described in the embodiment to be performed automatically may be performed manually, or the whole or part of the processes described in the embodiment to be performed manually may be performed automatically in known methods. In addition, the process procedures, the control procedures, the specific names, and the information including various data and parameters that have been illustrated in the description and the drawings may be changed as desired, except for the cases that have been specifically noted.

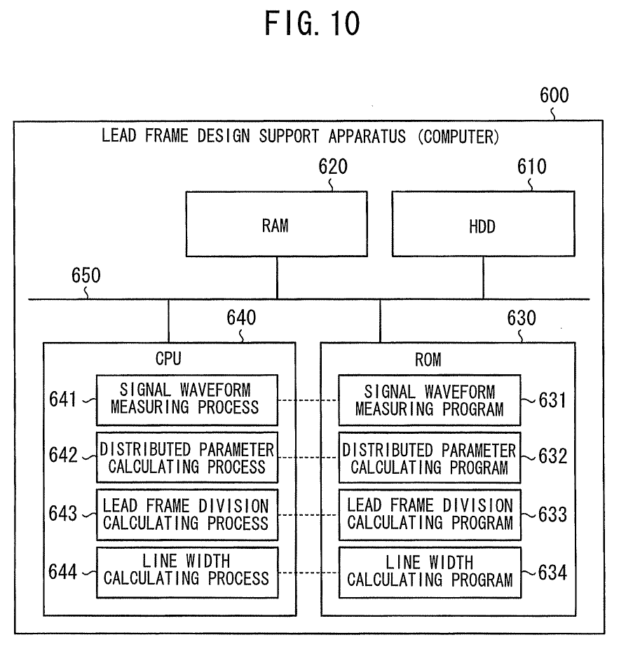

The various process(es) that have been described above may be implemented by executing a program that has been prepared in advance by a computer. Accordingly, in the following, an example of a computer that executes a program having the same functions as the above described embodiment will be described with reference to FIG. 10. FIG. 10 is a view illustrating a computer that executes a lead frame design support program.

As illustrated in FIG. 10, a computer 600 as a lead frame design support apparatus includes a HDD 610, RAM 620, a ROM 630, and a CPU 640, which are connected to each other by a bus 650.

The ROM 630 stores a lead frame design support program that exhibits the same functions as the foregoing embodiment. Namely, a signal waveform measured program 631, a distributed parameter calculated program 632, a lead frame division calculating program 633, and a line width calculating program 634 are stored in advance, as illustrated in FIG. 10. It should be noted that the programs 631 through 634 may be integrated or distributed as appropriate, like the components of the lead frame design support apparatus illustrated in FIG. 1.

Then, the CPU 640 reads out the programs 631 through 634 from the ROM 630 and executes the programs, whereby the programs 631 through 634 function as a signal waveform measuring process 641, a distributed parameter calculating process 642, a lead frame division calculating process 643, and a line width calculating process 644, respectively, as illustrated in FIG. 10. The respective processes 641 through 644 corresponds to the signal waveform measuring unit 13a, the distributed parameter calculating unit 13b, the lead frame division calculating unit 13c, the line width calculating unit 13d in the control unit 13, illustrated in FIG. 10, respectively.

Then, the CPU 640 registers various data into the HDD 610. It reads out the various data from the HDD 610 and stores them into the RAM 620, and it executes the processes based on the data stored in the RAM 620.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A lead frame design support apparatus, comprising:
a signal waveform measuring unit that measures a signal waveform transition time;
a distributed parameter calculating unit that calculates a distributed parameter unit length based on the transition time measured by the signal waveform measuring unit;
a division calculating unit that calculates a division number for a lead frame by dividing the lead frame by the distributed parameter unit length calculated by the distributed parameter calculating unit; and
a line width determining unit that determines a respective line width for each lead frame divided by the division number calculated by the division calculating unit, based on a signal waveform quality.

2. The lead frame design support apparatus as set forth in claim 1, wherein the signal waveform measuring unit measures a rise time or a fall time of the signal waveform as the signal waveform transition time.

3. The lead frame design support apparatus as set forth in claim 1, wherein the line width determining unit determines the line width to be thinned when a resistance is to be increased.

4. The lead frame design support apparatus as set forth in claim 1, wherein the line width determining unit determines the line width to be thickened when a resistance is to be decreased.

5. The lead frame design support apparatus as set forth in claim 1, wherein the line width determining unit determines the line width so that a portion in which the line width is thick and a portion in which the line width is thin are alternated, when an impedance is to be adjusted.

6. A lead frame design support method for designing a lead frame, comprising:
measuring a signal waveform transition time;
calculating a distributed parameter unit length based on the measured transition time;
calculating a division number for a lead frame by dividing the lead frame by the calculated distributed parameter unit length; and
determining a respective line width for each lead frame divided by the calculated division number, based on a signal waveform quality.

7. The lead frame design support method as set forth in claim 6, wherein measuring the signal waveform measures a rise time or a fall time of the signal waveform as the signal waveform transition time.

8. The lead frame design support method as set forth in claim 6, wherein determining the line width determines the line width to be thinned when a resistance is to be increased.

9. The lead frame design support method as set forth in claim 6, wherein determining the line width determines the line width to be thickened when a resistance is to be decreased.

10. The lead frame design support method as set forth in claim 6, wherein determining the line width determines the line width so that a thick portion and a thin portion of the line width are alternated when an impedance is to be adjusted.

11. A medium readable by a computer storing a program causing the computer to execute an operation including a lead frame design support, comprising:
measuring a signal waveform transition time;
calculating a distributed parameter unit length based on the measured transition time;
calculating a division number for a lead frame by dividing the lead frame by the calculated distributed parameter unit length; and
determining a respective line width for each lead frame divided by the calculated division number, based on a signal waveform quality.

12. A computer implemented method, comprising:
calculating a respective line width of each lead frame including based on a signal waveform transition time; and
controlling a signal waveform quality in accordance with a value resulting from said calculating.
